(19) United States
(12) Patent Application Publication
(10) Pub. No.: US 2012/0124581 A1
(43) Pub. Date: May 17, 2012

(54) VIRTUAL COMPUTER SYSTEM AND CONTROL METHOD OF VIRTUAL COMPUTER SYSTEM

(75) Inventor: Hideyuki Nitta, Tokyo (JP)

(73) Assignee: Hitachi, Ltd.

(21) Appl. No.: 13/384,688

(22) PCT Filed: Aug. 24, 2010
(86) PCT No.: PCT/JP2010/064229

§ 371 Date: Jan. 18, 2012

(30) Foreign Application Priority Data
Mar. 10, 2010 (JP) 2010-053279

(51) Int. Cl. G06F 9/455

(52) U.S. Cl. 718/1

(57) ABSTRACT

It is provided a virtual computer system, comprising a physical computer, a virtualization unit and a storage apparatus. The storage apparatus includes a first storage unit and a second storage unit. The virtualization unit includes file link information containing a correspondence relation, and a file control unit. The file control unit receives an access from the virtual computer to a file stored in the first storage unit, determines whether absence or presence of a correction file to be applied to the file by referring to the file link information, provides the file for which the access has been received from the first storage unit in a case where there is no correction file to be applied to the file, and provides a correction file in the second storage unit as the file in a case where there is the correction file to be applied to the file.

### BACKGROUND OF THE INVENTION

This invention relates to a technology for maintaining each of a plurality of OSs and the like in a virtual computer system for operating the plurality of OSs.

In recent years, because the semiconductor manufacturing technology has recently developed, the multi-core technology for mounting a plurality of processor cores on a single processor has been developed, resulting in an increase in processing performance of the processor. As the processing performance of the processor increases, the processor with enhanced performance can be efficiently used by employing the virtual computer technology for operating a plurality of virtual computers on a single computer.

The virtualization technology operates virtualization software, specifically, so-called virtual machine monitor (VMM) or hypervisor, on the computer, thereby generating virtual computers on the virtualization software. An independent OS can operate as a guest OS on each of the virtual machines.

Correction files (or correction programs or patch files) are frequently distributed to an OS, which is operating as a guest, for resolving security holes and bugs. In addition to a plurality of types of OS, versions (such as 2000, 2003, and 2008) for each of the types are often operating in a data center operating a large number of computers, and there are a plurality of types of updates (such as SP1, SP2, and kernels 2.6.1.4 and 2.6.1.6) within each of the versions, and it is thus required for an administrator to manage correction files to be applied to each of the OSs for each of the types of OS, the versions, and the types of update, and to apply the correction files to each of the guest OSs. Regarding the management and application of the correction files, the labor of the administrator and the like becomes excessive as the number of computers increases.

To address this problem, technologies disclosed in Japanese Patent Application Laid-open Nos. 2003-015894 and 2009-146403 are known as technologies for automatically applying correction files to each of the computers. The technology disclosed in Japanese Patent Application Laid-open No. 2003-015894 decouples, out of computers constructing a cluster, a computer to which a patch file is to be applied from the cluster, and applies the patch file after the decoupling. The patch file is applied by an agent deployed to each of the computers. Moreover, the technology disclosed in Japanese Patent Application Laid-open No. 2009-146403 distributes update files in parallel to a plurality of devices, and the update file is applied on each of the devices.

In recent years, because the importance of the security measures increases, in order to distribute and apply correction files, a method of distributing, by a management computer, correction files to subject computers, and applying the correction files on each of the computers is generally employed, which is the same as in the conventional case.

When a correction file is applied, a computer may need to be restarted, and it is thus necessary to set up a plan of applying correction files without stopping a service provided by each of the computers in a data center operating many computers, and there is a problem in that even when correction files with a high degree of urgency such as security patches against a zero-day attack have to be applied immediately, for example, the correction files cannot be applied at once.

In other words, the correction files are applied to a plurality of computers at once, a processing load increases on each of the computers due to execution of a program for applying the correction file, and hence resources may become deficient on the computers, and a long period may be required until the application of the correction file completes. Therefore, processing for services provided by the computers may be delayed. When a virtual computer is used, when a program for applying correction files at once to a plurality of virtual computers is executed, there arises a problem in that a load on the physical computer may become excessive.

Moreover, the computer needs to be active when the correction file is applied according to the above-mentioned conventional technologies, and the correction file cannot thus be applied to a computer stopped in a cold standby state, for example. Therefore, there is also a problem in that the computer has to operate while vulnerability against the zero-day attack and the like remain when the computer starts.

### SUMMARY OF INVENTION

This invention has been made in view of the above-mentioned problems, and therefore has an object to apply correction files to a plurality of computers at once. This invention also has an object to enable a virtual computer to use a correction file when the virtual computer starts in an environment in which the virtual computer is used.

The representative one of inventions disclosed in this application is outlined as follows. There is provided a virtual computer system, comprising: a physical computer including a processor and a memory; a virtualization unit for providing a virtual computer by dividing a resource of the physical computer; and a storage apparatus accessible from the physical computer. The storage apparatus includes a first storage unit storing a plurality of files for starting the virtual computer, and a second storage unit storing a correction file to be applied to the file. The virtualization unit includes file link information containing a correspondence relation between a file in the first storage unit and a correction file in the second storage unit, which is to be applied to the file, and a file control unit for controlling access from the virtual computer to the file in the storage apparatus. The file control unit receives an access from the virtual computer to a file stored in the first storage unit, determines whether absence or presence of a correction file to be applied to the file by referring to the file link information, provides the file for which the access has been received to the virtual computer from the first storage unit in a case where there is no correction file to be applied to the file, and provides a correction file in the second storage unit to the virtual computer as the file for which the access has been received in a case where there is the correction file to be applied to the file.

According to an embodiment of this invention, it is possible to apply the correction file to the plurality of virtual computers at once.

### BRIEF DESCRIPTION OF THE DRAWINGS

FIG. 1 is a block diagram illustrating an example of a configuration of a virtual computer system according to an embodiment of this invention.

FIG. 2 is a block diagram illustrating an example of a configuration of a management server according to the embodiment of this invention.

FIG. 3 is a block diagram illustrating an example of a configuration of a physical server according to the embodiment of this invention.

FIG. 4 is a conceptual diagram illustrating a processing of providing patch files, which is carried out by a virtual image control module according to the embodiment of this invention.

FIG. 5 is a conceptual diagram illustrating distribution processing of patch files, which is carried out by the virtual image control module according to the embodiment of this invention.

FIG. 6 is a chart illustrating a relationship between a time elapsed from a start of a patch distribution processing and a load on a patch disk.

FIG. 7 is an explanatory diagram illustrating an example of a physical server management table managed by a virtualization mechanism management module according to the embodiment of this invention.

FIG. 8 is an explanatory diagram illustrating an example of a virtual server management table managed by the virtualization mechanism management module according to the embodiment of this invention.

FIG. 9 is an explanatory diagram illustrating an example of a patch management table managed by a patch management module according to the embodiment of this invention.

FIG. 10 is an explanatory diagram illustrating an example of a virtual disk management table managed by the patch management module according to the embodiment of this invention.

FIG. 11 is an explanatory diagram illustrating an example of a file link table managed by a virtual image control module of a virtualization mechanism according to the embodiment of this invention.

FIG. 12 is a flowchart illustrating an example of registration processing for patch files carried out by the patch management module of the management server according to the embodiment of this invention.

FIG. 13 is a flowchart illustrating an example of registration processing for patch files carried out by the virtualization mechanism management module according to the embodiment of this invention.

FIG. 14 is a flowchart illustrating an example of a processing carried out by a file information collection module of the virtualization mechanism according to the embodiment of this invention.

FIG. 15 is a flowchart illustrating an example of a processing carried out by a file remapping module of the virtual image control module according to the embodiment of this invention.

FIG. 16 is a flowchart illustrating an example of processing carried out by a file control module of the virtual image control module according to the embodiment of this invention.

FIG. 17 is a flowchart illustrating an example of a patch distribution processing carried out by a patch distribution module in the virtual image control module according to the embodiment of this invention.

### DETAILED DESCRIPTION OF THE PREFERRED EMBODIMENTS

A description is now given of an embodiment of this invention referring to the accompanying drawings.

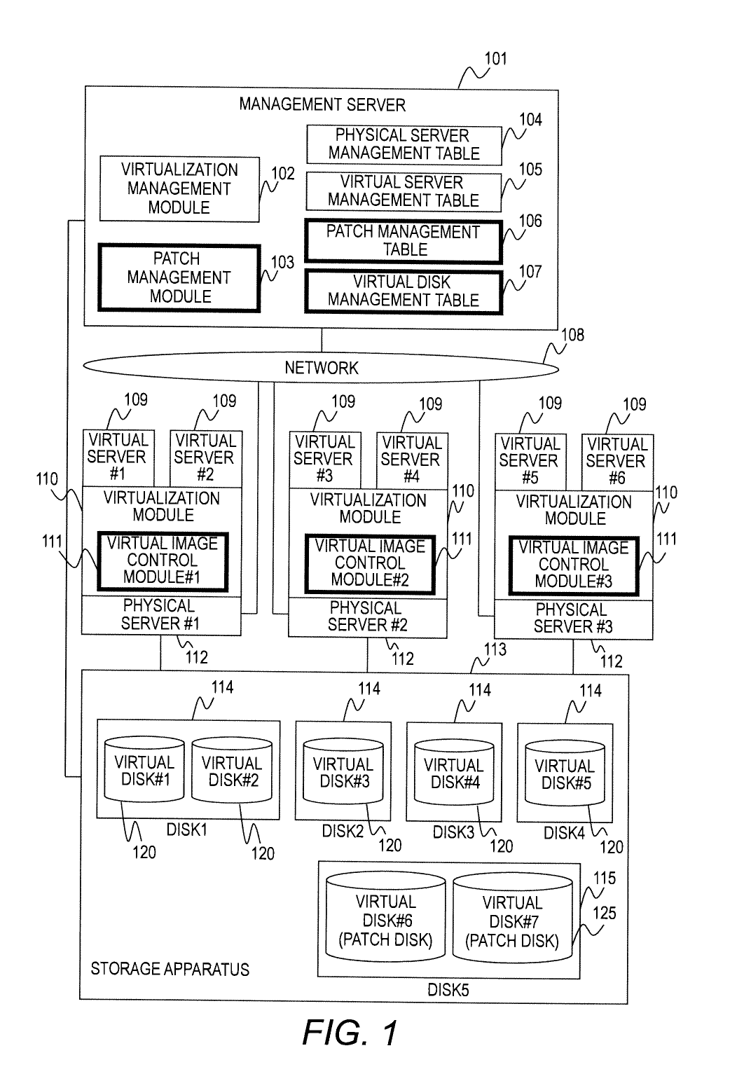

FIG. 1 illustrates an embodiment of this invention, and is a block diagram illustrating an example of a configuration of a virtual computer system.

The virtual computer system mainly includes a plurality of physical servers (physical computers) 112 executing a plurality of virtual servers (virtual computers) 109 on a virtualization mechanism (virtualization unit) 110, a management server 101 for managing the plurality of physical servers 112 and a storage apparatus 113, a network 108 for coupling the management server 101 and the plurality of physical servers 112, and the storage apparatus 113 which is coupled to the management server 101 and the physical servers 112 and stores information.

The virtualization mechanism 110 operating on the physical server 112 is constructed by a hypervisor or a virtual machine monitor (VMM), divides computer resources of the physical server 112, and assigns the divided resources to the virtual servers 109. The plurality of physical servers 112 have the same configuration, and the respective physical servers 112 are identified by numerals #1-#3. Moreover, the respective virtual servers 109 have the same configuration, and are identified by numerals #1-#6. FIG. 1 illustrates a state in which the virtual server #1 and the virtual server #2 are running on the physical server #1.

The storage apparatus 113 includes a plurality of disk devices (physical disks) 114, 115, and virtual disks 120, 125 are set to each of the disk devices 114. A boot image of the virtual server 109 is stored in the virtual disk 120 set to the disk device 114. The boot image can include system files of an OS, middleware, applications, and the like, which are executed on the virtual server 109. It should be noted that at least one virtual disk 120 is assigned to one virtual server 109.

Moreover, the virtual disks 125 set to the disk device 115 store patch files (correction files) of the OS and the like executed on the virtual server 109, and function as patch disks. The virtual disks #6, #7 are patch disks in the illustrated example. The virtual disks 125 are considered as the patch disks 125 in the following description. Common patch files such as those for the OS and the like executed on each of the virtual servers 109 are stored in the patch disk 125. Under control of a virtual image control module 111 of the virtualization mechanism 110 as described later, each of the virtual servers 109 reads files from the patch disk in place of the boot image as necessary, thereby operating in a state in which patch files are applied. The patch file stored in the patch disk 125 functions as a common patch file to be read by the plurality of virtual servers 109. As the patch files, correction files in accordance with the type and the version of the OS, and a level of update are stored, and the use of the patch file is managed by a patch management module 103 described later.

The management server 101 manages the physical servers 112, the virtual servers 109, and the virtual disks 120, 125. Therefore, the management server 101 includes a virtualization mechanism management module 102 for managing the virtualization mechanisms 110 of the respective physical servers 112, a physical server management table 104 for managing resources and operation states of the respective physical servers 112, a virtual server management table 105 for managing resources assigned to the respective virtual servers 109 and for managing operation states of the respective virtual servers, a patch management module 103 for applying patch files to the virtual servers 109, a patch management table 106 for managing the patch files stored in the patch disks 125, and a virtual disk management table 107 for managing application states of patch files for the respective virtual disks 120.

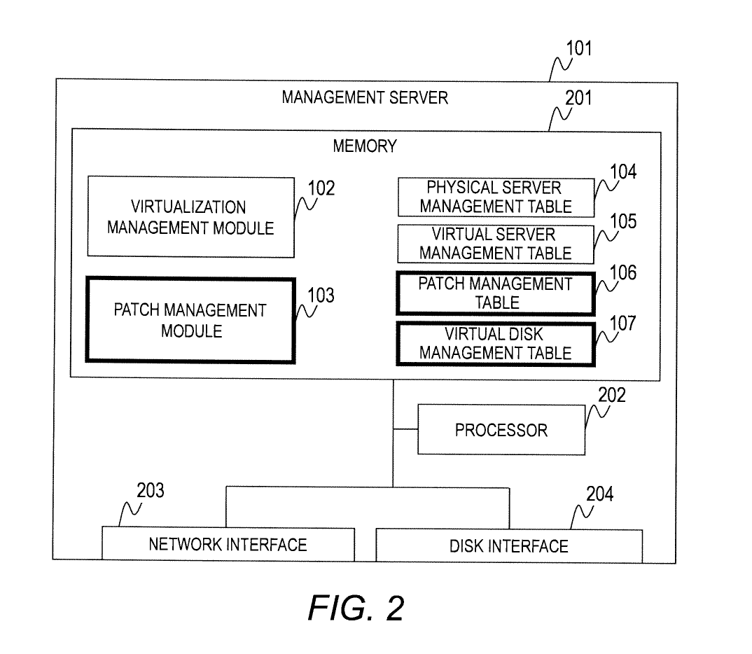

FIG. 2 illustrates the embodiment of this invention, and is a block diagram illustrating an example of a configuration of the management server 101. The management server 101 includes a processor 202 for carrying out arithmetic processing, a memory 201 for storing data and programs, a network interface 203 for accessing to the network 108, and a disk interface 204 for accessing to the storage apparatus 113.

The virtualization mechanism management module 102 and the patch management module 103 are loaded as programs and are executed by the processor 202 in the memory 201, and the above-mentioned tables 104-107 are each stored in the memory 201 by the virtualization mechanism management module 102 and the patch management module 103.

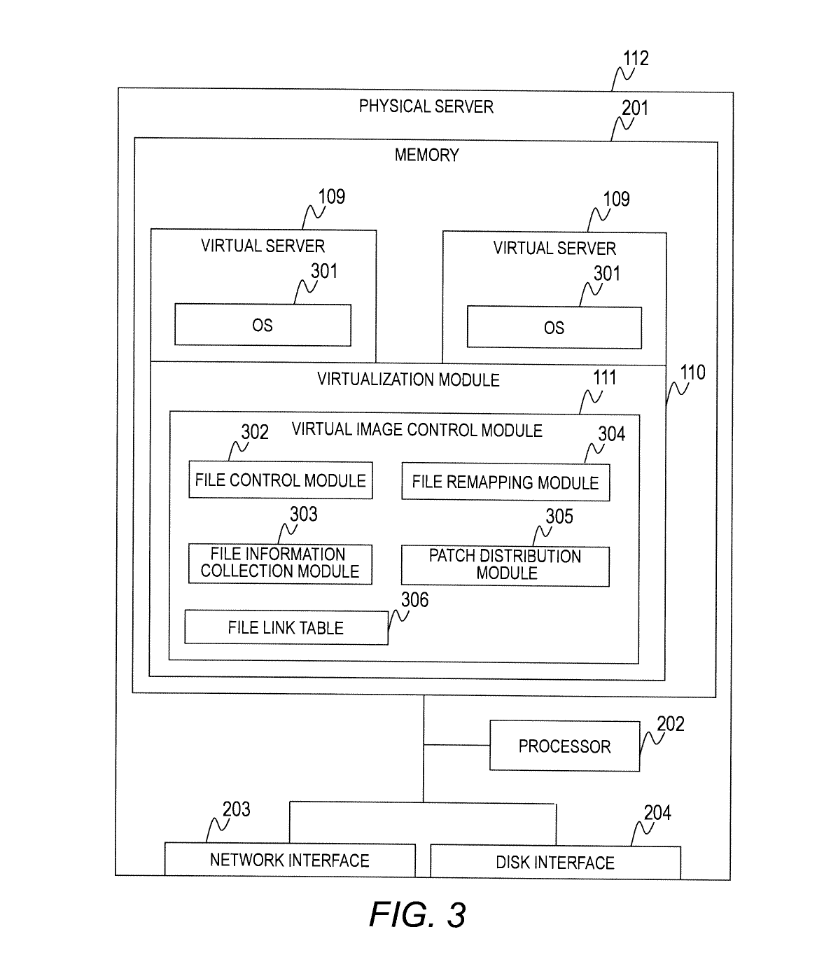

FIG. 3 illustrates the embodiment of this invention, and is a block diagram illustrating an example of a configuration of the physical server 112. The hardware configuration of the physical server 112 is the same as that of the management server 101, and includes the processor 202, the memory 201, the network interface 203, and the disk interface 204, and is different from the management server 101 in programs and data stored in the memory 201.

The virtualization mechanism 110 for assigning computer resources of the physical servers 112 to the plurality of virtual servers 109 is loaded in the memory 201 of the physical server 112, and is executed by the processor 202. The plurality of virtual servers 109 are executed on the virtualization mechanism 110, and an OS 301 and applications (not shown) are executed on each of the virtual servers 109. The virtualization mechanism 110 divides the computer resources of the physical server 112 and assigns the divided resources to the plurality of virtual servers 109 under instructions of the management server 101. Moreover, the virtualization mechanism 110 assigns, under instructions of the management server 101, the virtual disk 120 in the storage apparatus 113 to be coupled to the virtual server 109, and the virtual server 109 reads a boot image containing the OS 301 from the assigned virtual disk 120, thereby starting up.

It should be noted that the virtualization mechanism 110 includes a virtual image control module 111 for determining whether or not patch files in the patch disks 125 should be applied to the virtual server 109 and for controlling the virtual server 109 to read the patch files as necessary. The virtual image control module 111 includes a file link table 306 to which storage locations (positions) of patch files to be applied to the respective virtual servers 109 on the physical server 112 and files (system files) of the boot image to which the patch files are to be applied are set in advance, a file control module 302 for referring to the file link table 306 when the virtual disk 120 for each of the virtual servers 109 is accessed, thereby determining necessity of application of patch files and for controlling the virtual server 109 to read the patch files on the patch disks 125 when the application of the patch files is necessary, a file information collection module 303 for acquiring the virtual disks and positions of files to which the patch files are to be applied for each of the virtual servers 109, a patch distribution module 305 for writing the patch files to the virtual disks 120 when a predetermined condition is satisfied, and a file remapping module 304 for writing relationships between files to which patch files are to be applied and the patch files to the file link table 306.

### <Processing Overview>

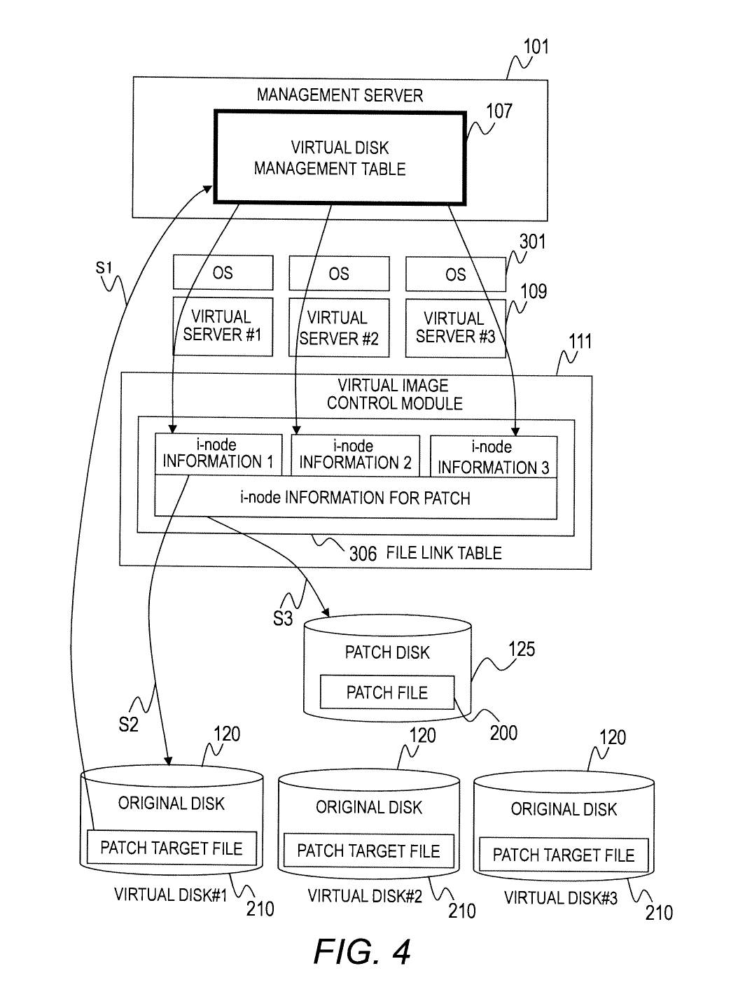

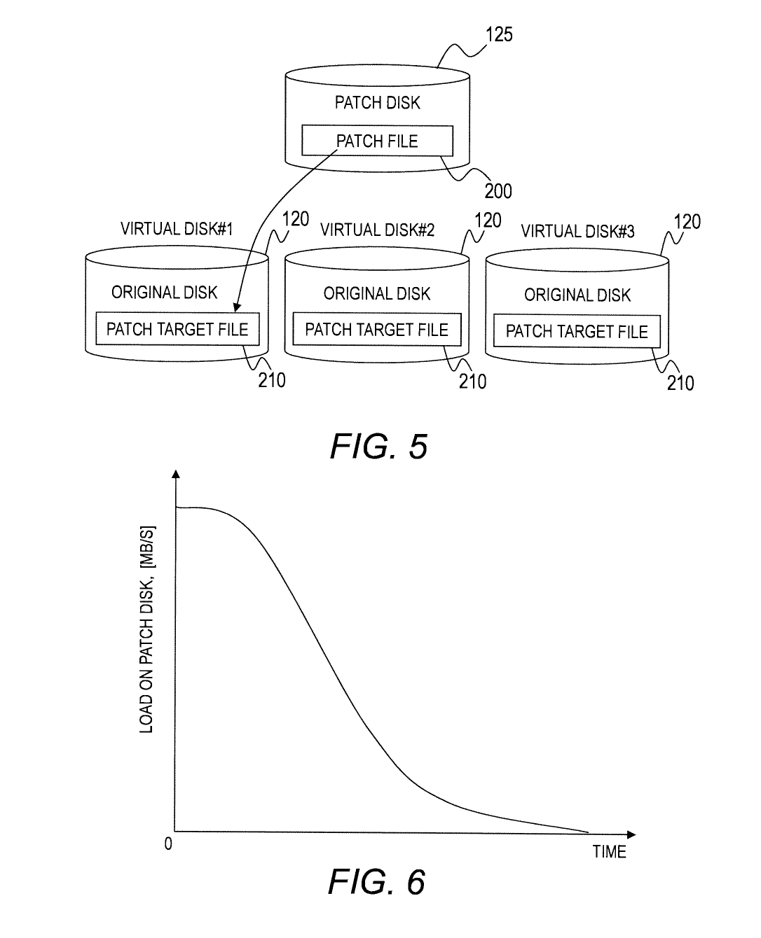

A description is now given of an overview of the virtual image control module 111 included in the virtualization mechanism 110 referring to FIGS. 4 and 5. FIG. 4 is a conceptual diagram illustrating processing of providing a virtual server with patch files, which is carried out by the virtual image control module 111. FIG. 5 is a conceptual diagram illustrating the distribution processing of patch files carried out by the virtual image control module 111.

Referring to FIG. 4, a patch file 200 which the management server 101 controls a plurality of virtual servers 109 to share is stored in the virtual disk 125 in the storage apparatus 113, and a predetermined image is stored in the virtual disk 120 to be assigned to each of the virtual servers 109. In the example illustrated in FIGS. 4 and 5, the virtualization mechanism 110 of the physical server #1 illustrated in FIG. 1 assigns the virtual servers #1, #2 under instructions of the virtualization mechanism management module 102 of the management server 101 and assigns the virtual disk #1 to the virtual server #1. A publicly known or well-known technology can be applied to the technology for the virtualization mechanism 110 assigning the computer resources to the virtual server #1, and hence a detailed description is herein omitted.

Moreover, the virtualization mechanism management module 102 stores information on the virtual disks 120 to which patch files 200 are to be applied in the virtual disk management table 107, and stores application states of the patch files 200 for the virtual disk #1 assigned to the virtual server #1 in the virtual disk management table 107.

The file information collection module 303 of the virtual image control module 111 on the physical server #1 acquires, as described later, stored positions (file paths and a virtual disk identifier) of patch target files 210 to which the patch files 200 is to be applied by the management server 101, and stores the acquired stored positions as i-node information for patch in the file link table 306. Then, the file information collection module 303 acquires, from the virtual disk management table 107 of the management server 101, the locations of files to which the patch files 200 are to be applied, and stores the acquired locations as the i-node information (S1). It should be noted that a file to which a patch file 200 needs to be applied on the virtual disk #1 is referred to as patch target file 210. Moreover, the virtual disk 120 storing the boot image of the virtual server #1 and the patch target files 210 is referred to as original disk, and the virtual disk 125 storing the patch files 200 is referred to as patch disk in the following description.

When the management server 101 assigns the virtual server #1 to the virtualization mechanism 110 of the physical server #1 and assigns the virtual disk #1 to the virtual server #1, the virtual disk management table 107 of the management server 101 and the file link table 306 of the virtualization mechanism 110 of the physical server #1 are updated before the virtual server #1 starts.

When the virtual server #1 starts, the file control module 302 of the virtual image control module 111 comes to function. When the virtual server #1 accesses the original disk (virtual disk #1), the file control module 302 refers to the file link table 306, thereby determining whether or not the access request of the virtual server #1 is directed to the patch target file 210 on the original disk.

When the access request is not directed to a patch target file 210, the file control module 302 permits the access to the requested file on the virtual disk #1 in the same manner as in ordinary processing by the virtualization mechanism 110 (S2).

On the other hand, when the access request is directed to the patch target file 210, the file control module 306 permits the access to a file stored in the patch disk in place of the requested access to the virtual disk #1 as the processing by the virtualization mechanism 110 according to this invention (S3). An example in which the file control module 306 carries out the access request to the virtual disk #1 and responds to the virtual server #1 is described in this embodiment. However, the file control module 306 may switch a path to the virtual disk accessed by the virtual server #1. In other words, when the access request is not directed to the patch target file 210, the file control module 306 permits the access to the requested file on the virtual disk #1 in the same manner as in the ordinary processing by the virtualization mechanism 110, thereby causing the virtual server #1 to access to the virtual disk #1. On the other hand, when the access request is directed to the patch target file 210, the file control module 306 may switch the access path to the requested virtual disk #1 to a path to the patch disk, thereby causing the virtual server #1 to access the patch file 200.

Therefore, if the virtual server #1 accesses the patch target file 210 when the virtual server #1 accesses the virtual disk #1, the virtual server #1 substantially accesses the patch file 200 on the patch disk. On this occasion, the virtual image control module 111 provides the patch file 200 for the access to the patch target file 210 by the virtual server #1 by hiding the patch target file 210 on the original disk.

As a result of the above-mentioned processing, the virtual image control module 111 can operate the virtual server #1 in the same environment as that after the application of the patch file 200 without writing the patch file 200 to the original disk.

When an emergency correction for a security hole is provided as the patch file 200, an administrator or the like first stores the patch file 200 in the patch disk from the management server 101. The virtualization mechanism management module 102 determines a virtual server to which the patch file 200 is to be applied in accordance with the application state of the patch file in the virtual server management table 105, inquires, as described later, the file information collection module 303 of the virtual image control module 111 of an original disk storing the patch target file 210 to which the patch file 200 is to be applied, and identifies the virtual disk 120 (original disk) to which the patch file 200 is to be applied and the patch target file 210 in accordance with information on the patch file 200 on the patch disk and information on the original disk acquired by the file information collection module 303. The virtualization mechanism management module 102 then instructs the file remapping module 304 of the virtual image control module 111 to update the file link table 306. As a result, the file remapping module 304 of the virtual image control module 111 updates the file link table 306 and a relationship regarding the patch target file 210 to which the patch file 200 is applied is defined in the virtualization mechanism 110 of each of the physical servers 112.

When the virtual server accesses the patch target file 210 on the original disk to which the application of the patch file 200 is set in the virtual disk management table 107, the virtual image control module 111 provides the patch file 200 as a corrected file in place of the patch target file 210. As a result, when the virtual image control module 111 only stores the patch file 200 in the patch disk and updates the file link table 306, the virtual server can operate in a state after the patch file 200 is provided. The patch file 200 can immediately be supplied to the OS 301 and applications on the virtual server without carrying out the distribution processing which replaces the patch target file 210 with the patch file 200 on the original disk

In FIG. 4, the example of providing the one virtual server #1 with the patch file 200 is illustrated, but the one patch file 200 can be shared by a plurality of virtual servers 109 on a plurality of virtualization mechanisms 110 managed by the management server 101. Therefore, the patch file 200 on the patch disk can be treated as a common patch file among virtual servers 109. For example, if a patch target file 210 to which a patch file 200 is to be applied is simply defined in the file link tables 306 in the virtual servers #1-#3 in FIG. 4, when the virtual servers #1-#3 respectively access to the patch target files 210, the virtual image control modules 111 return the patch file 200 on the patch disk 125 in place of the patch target files 210 on the respective original disks. Before the patch target file 210 on the original disk is updated, the patch file 200 can be applied at once to a plurality of virtual servers in this way.

Further, according to this invention, it is possible to allow the virtual server 109 to execute the patch file 200 before the patch target file 210 on the original disk is updated by the patch file 200 and hence it is possible to control a stopped virtual server to use the patch file 200. In other words, when the position information (i-node information) on the patch file 200 in place of the patch target file 210 is registered to the virtual disk management table 107 and the file link table 306, the virtual image control module 111 can hide the patch target file 210 and provide the patch file 200 when the virtual server starts, and security against the zero-day attack to the OS 301 and applications can be ensured.

When the virtual image control module 111 hides the patch target file 210 on the original disk to provide a patch file 200 instead as described above, patch files 200 for one OS or application accumulate and processing by the file control module 302 increases. Therefore, when a predetermined condition is satisfied, as illustrated in FIG. 5, the virtual image control module 111 carries out the patch distribution processing for replacing the patch target file 210 on the original disk by the patch files 200 on the patch disk.

FIG. 5 illustrates an overview of the patch distribution processing carried out by the patch distribution module 305 in the virtual image control module 111.

When there is a patch target file 210 to which a patch file 200 is not applied on an original disk, the patch distribution module 305 monitors a load on a resource of the physical server #1, and when the load decreases below a threshold, applies the patch by updating the patch target file 210 on the original disk by using the patch file 200. A usage of the processor 202 (physical processor) or a usage of the storage apparatus 113 or the network 108 may be used as the load on the resource of the physical server #1.

When a plurality of virtual servers are operating on the one physical server #1, this processing can prevent a plurality of services provided by a plurality of virtual servers from being delayed by distributing a patch file 200 to an original disk when the load on the physical server #1 is low. Moreover, this invention can apply a patch file 200 to the virtual server #1 without writing the patch file 200 to an original disk, and the processing of writing the patch file 200 to the original disk thus needs not to be carried out immediately. The patch distribution module 305 thus sets the time for writing the patch file 200 to a plurality of virtual servers 109 when the load on the resource on the physical server #1 is lower than the predetermined threshold, and starts the distribution and application of the patch file 200. In other words, the patch file 200 is distributed by background processing. Moreover, an access to the patch target file is disabled until the application of the patch file 200 is completed.

Moreover, the load on the patch disk when a patch is distributed in parallel with many virtual servers 109 operating on the physical server #1 is illustrated in FIG. 6.

FIG. 6 is a chart illustrating a relationship between a time elapsed from the start of the patch distribution processing and the load on the patch disk. The load on the patch disk can be represented by a data transfer rate per unit time (MB/s), for example. The load on the patch disk is high at the beginning of the distribution of the patch file to the plurality of virtual disks 120, but the load on the patch disk gradually decreases as the distribution of the patch file 200 to the virtual servers 109 (virtual disks 120) progresses.

### <Processing in Detail>

A description is now given of details of processing carried out by the virtual computer system according to this invention.

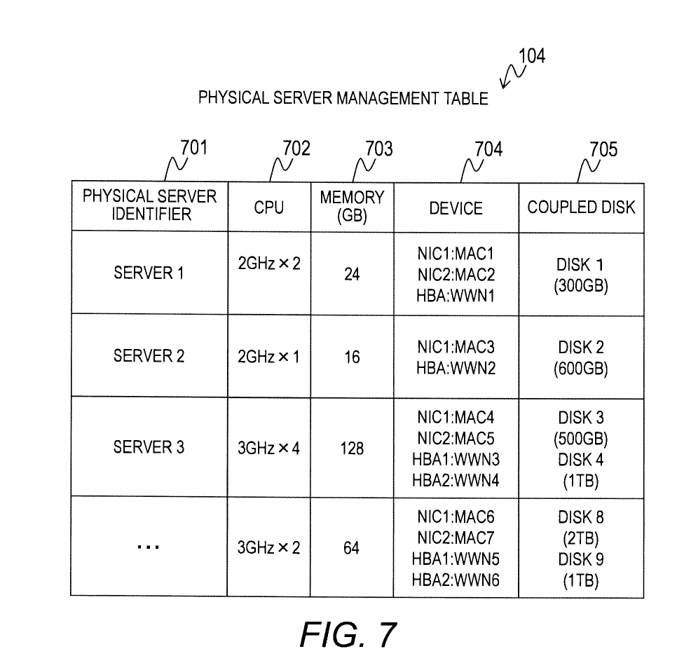

FIG. 7 shows the physical server management table 104 managed by the virtualization mechanism management module 102. One record of the physical server management table 104 is constructed by a physical server identifier 701 for storing an identifier of the physical server 112, a CPU 702 for storing information on performance of the processor 202, a memory 703 for storing a capacity of the memory 201, a device 704 for storing an identifier assigned to an I/O device provided for the physical server 112, and a coupled disk 705 for storing an identifier and a capacity of the disk device 114 of the storage apparatus 113 assigned to the physical server 112.

The identifier (such as #1-#3) assigned by the virtualization mechanism management module 102 is stored in the physical server identifier 701. An operation frequency and the number of cores of the processor 202 are stored in the CPU 702, and the capacity of the memory 201 are stored in the memory 703. Identifiers of all I/O devices provided for the physical server 112 (or coupled to the physical server 112) are stored in the device 704, in which a MAC address is stored when the type of the I/O device is a network interface and a WWN is stored for a case of a host bus adaptor (HBA). Identifiers and capacities of disk devices 114 accessible by the physical server 112 out of the disk devices 114 of the storage apparatus 113 are stored in the coupled disk 705.

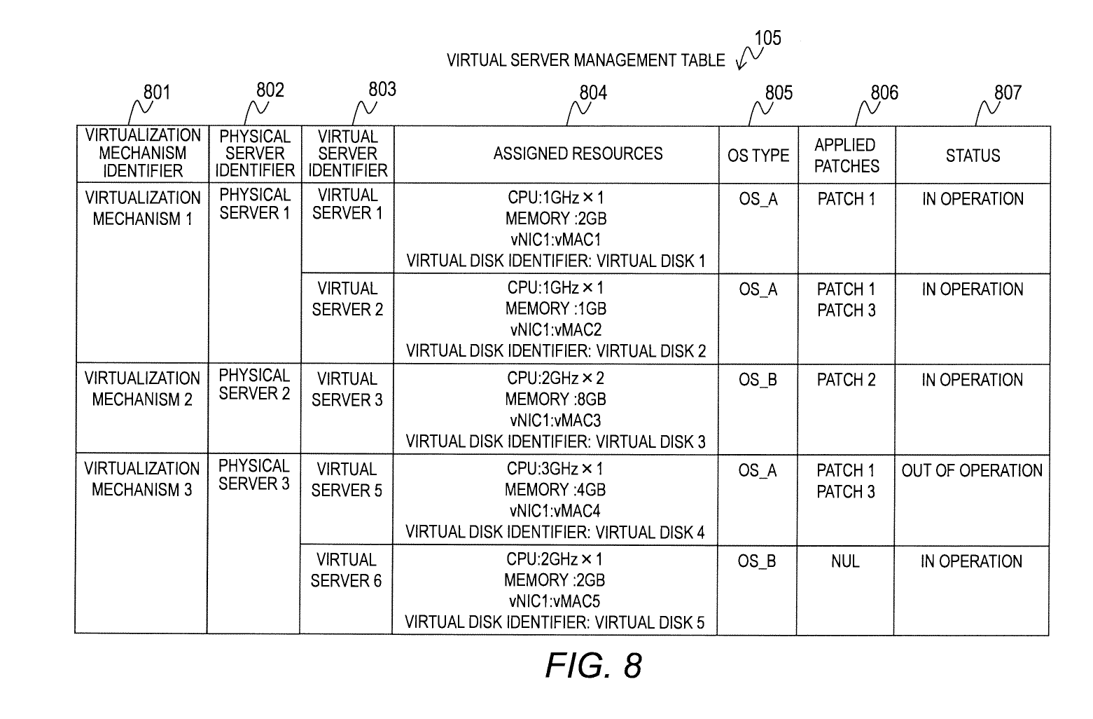

FIG. 8 shows the virtual server management table 105 managed by the virtualization mechanism management module 102. One record of the virtual server management table 105 includes a virtualization mechanism identifier 801 for storing an identifier of the virtualization mechanism 110 operating on the physical server 112, a physical server identifier 802 for storing an identifier of the physical server 112 on which the virtualization mechanism 110 is executed, a virtual server identifier 803 for storing an identifier of the virtual server 109 provided by the virtualization mechanism 110, an assigned resource 804 for storing resources of the physical server 112 and the storage apparatus 113 assigned to the virtual server 109, an OS type 805 for storing a type and a version of an OS executed by the virtual server 109, an applied patch 806 for storing an identifier of a patch which has been applied to the OS executed by the virtual server 109, and a status 807 for storing an operation state of the virtual server 109.

The identifier (such as #1-#3) of the virtualization mechanism 110 assigned by the virtualization mechanism management module 102 is stored in the virtualization mechanism identifier 801. The identifiers (such as #1-#6) of the virtual servers 109 assigned by the virtualization mechanism management module 102 are stored in the virtual server identifier 803. FIG. 8 shows an example of a state in which the virtual server #4 of the physical server #2 illustrated in FIG. 1 is not assigned.

Performance information on a processor (such as operation frequency×number of cores), a memory capacity, identifiers of I/O devices, and an identifier of a virtual disk which are assigned to the virtual server 109 are stored in the assigned resource 804. FIG. 8 shows an example in which the virtual disk #1 is assigned to the virtual server #1, and the virtual disk #2 is assigned to the virtual server #2 on the physical server #1.

Regarding the OS type 805, FIG. 8 shows an example in which the virtual servers #1, #2, and #5 execute OS_A, and the virtual servers #3 and #6 execute OS_B. The identifier of the patch which has been applied to the OS 301 executed by the virtual servers 109 are stored in the applied patch 806. FIG. 8 shows an example in which there are patches 1 and 3 for the OS_A, there is a patch 2 for the OS_B, only the patch 1 is applied to the OS_A of the virtual server #1, and the patch 3 is not applied, and patches are not applied to the OS_B of the virtual server #6. It should be noted that at least one patch file 200 is associated with the identifier of each of the patches 1-3 as described later.

Information on whether the virtual server 109 is in operation or not is stored in the status 807, and FIG. 8 shows an example in which the virtual servers #1, #2, #3, and #6 are in operation.

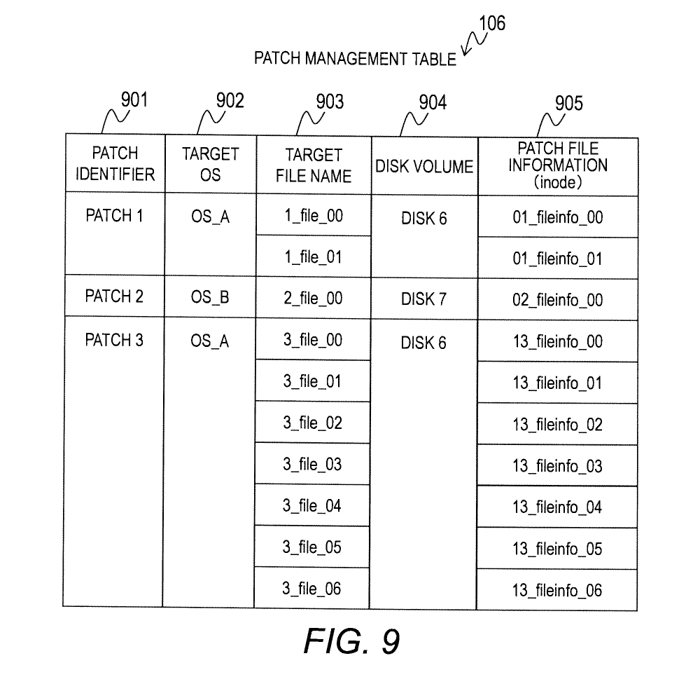

FIG. 9 shows an example of the patch management table 106 managed by the patch management module 103. One record of the patch management table 106 includes a patch identifier 901 of the applied patch 806 in the virtual server management table 105 of FIG. 8, a target OS 902 for storing a type of an OS as a target for the patch identifier, a target file name 903 for storing a file name to which the patch file 200 is applied, a disk volume 904 for storing an identifier of a virtual disk storing the patch file 200, and patch file information 905 for storing a position (such as file path, and i-node information) of the patch file 200.

FIG. 9 shows an example in which the patch 3 is a patch file group directed to the OS_A, and is stored in the virtual disk #6, the patch target files 210 to which the patch files 200 are applied are “3_file_{—}00”-“3_file_{—}06”, and positions of these files are represented by “13_fileinfo_{—}00”-“13_fileinfo_{—}06”. The patch management table 106 can be generated in advance by the administrator of the management server 101 or the like via the patch management module 103.

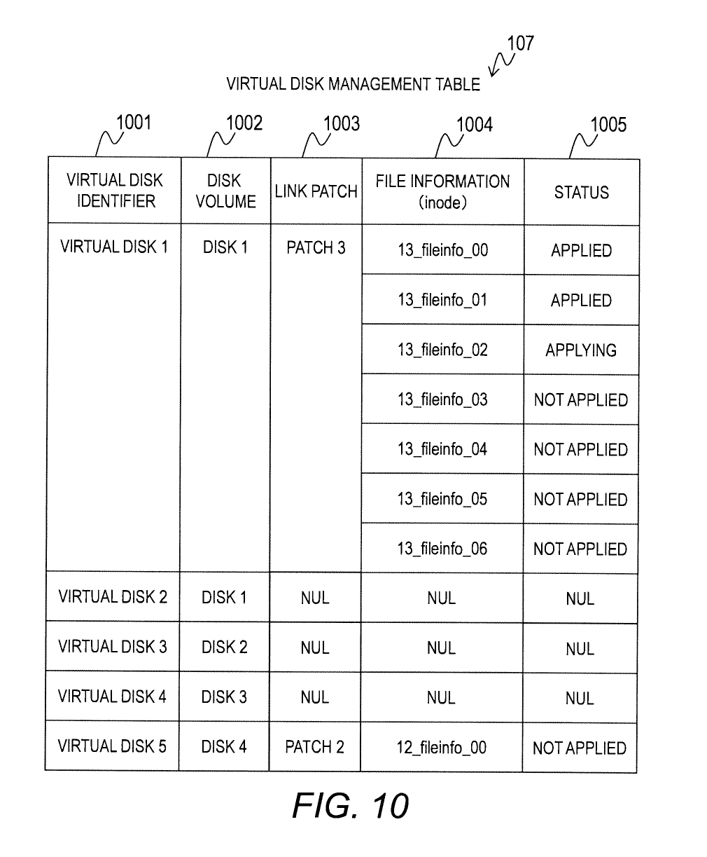

FIG. 10 shows an example of the virtual disk management table 107 managed by the patch management module 103. One record of the virtual disk management table 107 includes a virtual disk identifier 1001 for storing an identifier (such as #1-#5) of the virtual disk 120 storing a boot image of the virtual server 109, a disk volume 1002 for storing an identifier of the disk device 114 for storing the virtual disk, a link patch 1003 for storing a patch identifier to be applied to the virtual disk, file information 1004 for storing patch file information (corresponding to 905 of FIG. 9) on a patch file corresponding to the patch identifier, and a status 1005 indicating whether or not the patch file indicated in the file information is applied to the virtual disk.

In the example shown in FIG. 10, “NULL” indicating that there is no patch to be applied is stored for the virtual disks #2-#4, application of the patch 3 is stored for the virtual disk #1, and application of the patch 2 is stored for the virtual disk #5. Further, the statuses 1005 indicate that “13_fileinfo_{—}00” and “13_fileinfo_{—}01” of the patch 3 have been applied to the virtual disk #1, “13_fileinfo_{—}02” is being applied to the virtual disk #1, and “13_fileinfo_{—}03” to “13_fileinfo_{—}06” have not been applied to the virtual disk #1.

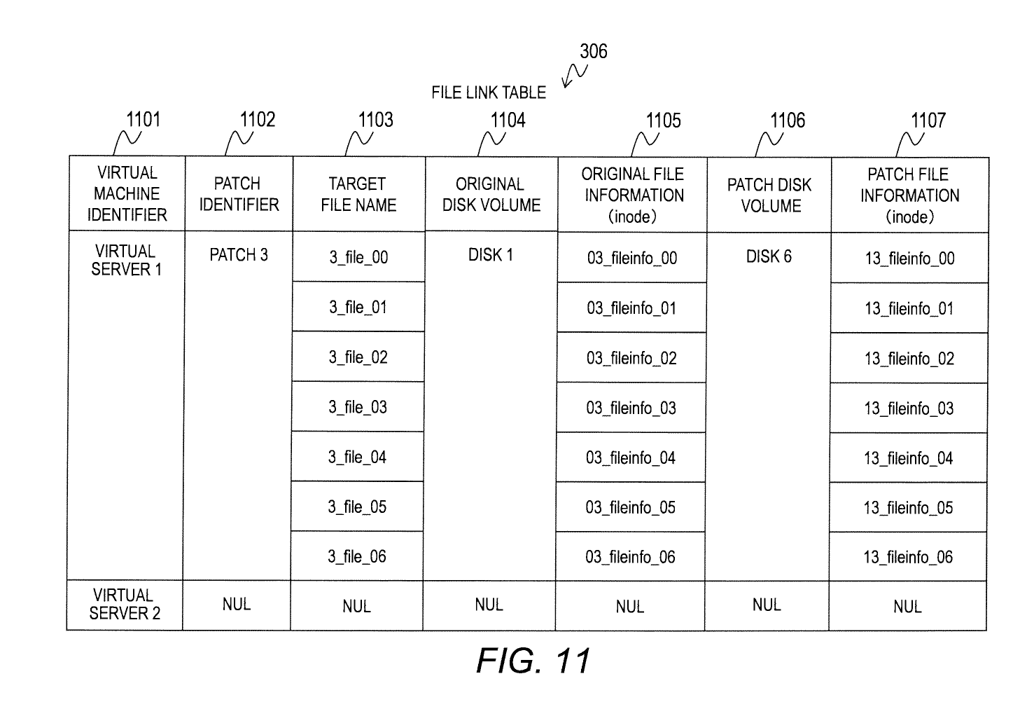

FIG. 11 shows one example of the file link table 306 managed by the virtual image control module 111 of each of the virtualization mechanisms 110. The file link table 306 is a table for managing a relationship among the virtual server 109 using the virtual disk 120 storing a boot image, a target file to which a patch is applied in the virtual disk 120, and a patch file.

One record of the file link table 306 includes a virtual machine identifier 1101 for storing an identifier of the virtual server 109 to which a patch file is applied, a patch identifier 1102 for storing an identifier of the patch to be applied, a target file name 1103 for storing a file name on the virtual disk 120 to which the patch file is applied, an original disk volume 1104 for storing an identifier of the virtual disk 120 to which the patch file is applied, original file information 1105 for storing a position of the patch target file 210 on the virtual disk 120, a patch disk volume 1106 for storing an identifier of the virtual disk 125 storing the patch file to be applied, and patch file information 1107 for storing a position of the patch file.

FIG. 11 shows an example in which seven patch files of the patch 3 are applied to the virtual disk #1 assigned to the virtual server #1, and the patch files to be applied are stored in the virtual disk #6. “NULL” is stored in each of entries for the virtual server #2, which indicates that there is no patch file to be applied.

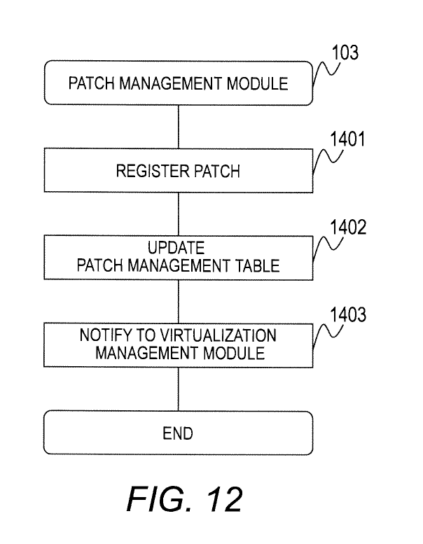

FIG. 12 is a flowchart illustrating an example of registration processing for patch files carried out by the patch management module 103 of the management server 101. This processing is carried out in accordance with an instruction by the administrator of the management server 101 or the like, and is started when the administrator or the like registers the patch files 200 to a patch disk (virtual disk 125).

In Step 1401, the patch management module 103 of the management server 101 receives positions of the patch files 200, a patch disk (virtual disk 125) of a storage destination, and storage positions (patch file information 905) which are contained in the instruction of the administrator, and writes the specified patch files in the specified storage positions on the virtual disk 125. It should be noted that the administrator instructs the target OS 902 of the patch files 200, the patch identifier 901, the target file name 903 of the patch, the virtual disk 125 (disk volume 904) which is a storage destination of the patch files, and storage positions of the patch files on the virtual disk 125 to the management server 101.

In Step 1402, the patch management module 103 registers the information on the patch files 200 written to the storage positions on the virtual disk 125 to the patch management table 106. This processing generates new records in the patch management table 106, and registers the patch files 200.

In Step 1403, the patch management module 103 notifies the virtualization mechanism management module 102 of the new patch identifier 901 added to the patch management table 106.

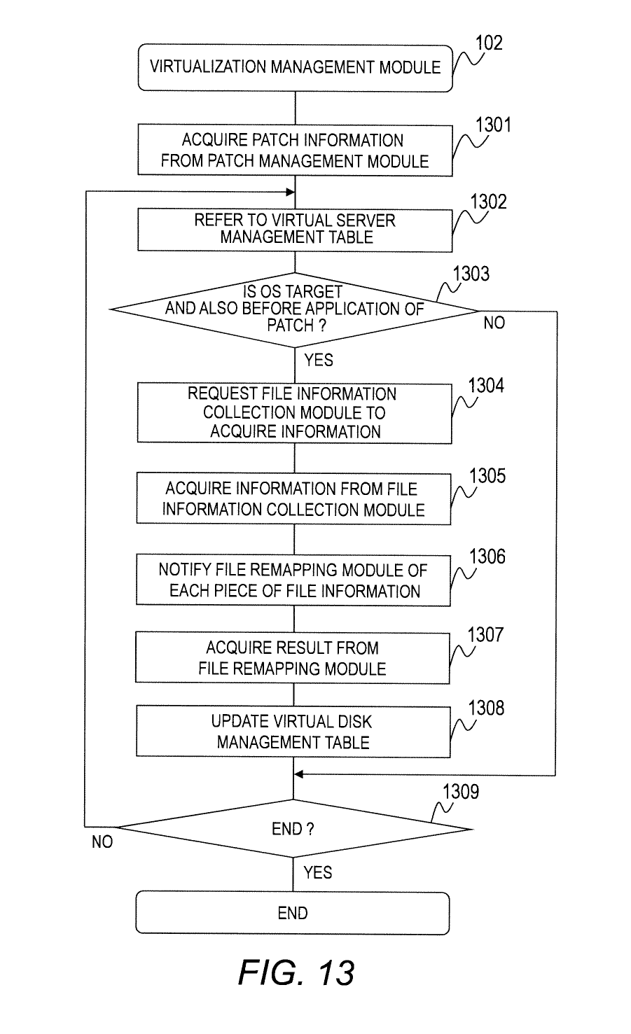

As a result of this processing, the new patch files 200 are stored in the virtual disk 125, and the new records are added to the patch management table 106. It should be noted that the patch notification processing in Step 1403 may notify the new patch identifier and the patch files 200 when the virtualization mechanism management module 102 makes an inquiry in Step 1301 of FIG. 13 described later.

Next, FIG. 13 is a flowchart illustrating an example of registration processing for patch files carried out by the virtualization mechanism management module 102. This processing is started by an instruction by the administrator when patch files are registered. Alternatively, the processing of FIG. 13 may be carried out after the processing of FIG. 12 is finished.

In Step 1301, the virtualization mechanism management module 102 acquires information on the patch files 200 (such as the patch identifier 901, the target OS 902, and the target file name 903) from the patch management module 103. The patch management module 103 notifies the information on the patch files 200 registered to the patch management table 106 in response to the inquiry from the virtualization mechanism management module 102. The patch management module 103 may notify information only on the patch files 200 newly added to the patch management table 106, or the entire patch files 200 in the patch management table 106. It should be noted that a flag indicating whether a newly registered patch file 200 has been notified to the virtualization mechanism management module 102 (not shown) may be provided in the patch management table 106, thereby identifying the patch file 200 to be notified.

Processing from Step 1302 to Step 1309 is repeated in accordance with the number of patch files 200 acquired in Step 1301 and the number of the virtual servers in the virtual server management table 105 subsequently to Step 1302. It should be noted that when there are a plurality of acquired patch files 200, the virtualization mechanism management module 102 selects one patch file 200 as a patch file 200 of interest, and repeats the subsequent processing for each of the patch files 200.

In Step 1302, the virtualization mechanism management module 102 first refers to the virtual server management table 104 of FIG. 8 sequentially starting from the first record, and in Step 1303, determines whether or not the OS type 805 being executed on the virtual server coincides with the target OS 902 of the patch file 200 acquired in Step 1301, and the patch identifier 901 of the patch file 200 of present interest has not been applied.

The virtualization mechanism management module 102 refers to the virtual server management table 105, and determines that the patch has not been applied to the virtual server 109 when the patch identifier 901 of the acquired patch file 200 is not contained in the applied patch 806.

When the OS type 805 running on the virtual server 109 and the OS type 805 to which the patch file 200 is to be applied coincide with each other, and the patch file 200 has not been applied, the virtualization mechanism management module 102 sets the identifier (virtual server identifier 803) of the virtual server 109 as a target virtual server identifier, and proceeds to Step 1304. On the other hand, the OS types do not coincide with each other, or the patch file 200 has been applied, the virtualization mechanism management module 102 proceeds to Step 1309.

In Step 1304, the virtualization mechanism management table 102 requests the file information collection module 303 of the virtualization mechanism 110 providing the virtual server 109 executing the OS 301 coincident with the target OS 902 to acquire the position of the patch target file 210 (target file name 903) to which the patch file 200 is to be applied in accordance with the target virtual server identifier. As described later, the file information collection module 303 acquires a position of the patch target file corresponding to the target file name 903 out of files stored in the virtual disk 120 assigned to the virtual server 109, and an identifier of the virtual disk 120 in which the patch target file is stored.

In Step 1305, the virtualization mechanism management module 102 acquires the position of the patch target file corresponding to the patch target file name 903 in the virtual disk 120, and the identifier of the virtual disk 120 in which the patch target file is stored, which are collected by the file information collection module 303 from the virtualization mechanism 110.

In Step 1306, the virtualization mechanism management module 102 notifies the file remapping module 304 of the virtualization mechanism 110 of the target virtual server identifier, the patch identifier 901 of the patch file 200 of present interest, the identifier of the virtual disk 125 (disk volume 904), the position (patch file information) of the patch file 200, the target file name 903, the position of the patch target file name 903 acquired in Step 1305, and the identifier of the virtual disk 120 storing the patch target file corresponding to the patch target file name 903, and requests to update the file link table 306.

In Step 1307, the virtualization mechanism management module 102 receives a notification that the contents of the file link table 306 have been updated from the file remapping module 304.

In Step 1308, the virtualization mechanism management module 102 adds the information on the patch file 200 of present interest to the virtual disk management table 107. In other words, the virtualization mechanism management module 102 stores the identifier of the virtual disk 120 to which the patch file 200 of present interest is to be applied in the virtual disk identifier 1001 in the virtual disk management table 107, stores the identifier of the virtual disk 120 to which the patch file 200 is to be applied in the disk volume 1002, stores the patch identifier of the patch file 200 in the link patch 1003, adds the position (patch file information 905) of the patch file 200 to the file information 1004, and sets “NOT APPLIED” to the status 1005.

In Step 1309, the virtualization mechanism management module 102 determines whether the above-mentioned processing has been completed for all the virtual servers 109 and all the patch files 200 acquired in Step 1301. When the processing has not been completed for all the virtual servers 109 and all the patch files 200, the virtualization mechanism management module 102 repeats the above-mentioned processing for a next patch file 200 or a next virtual server 109. On the other hand, the processing has been completed for all the virtual servers 109 and all the patch files 200, the virtualization mechanism management module 102 finishes the processing in this flowchart.

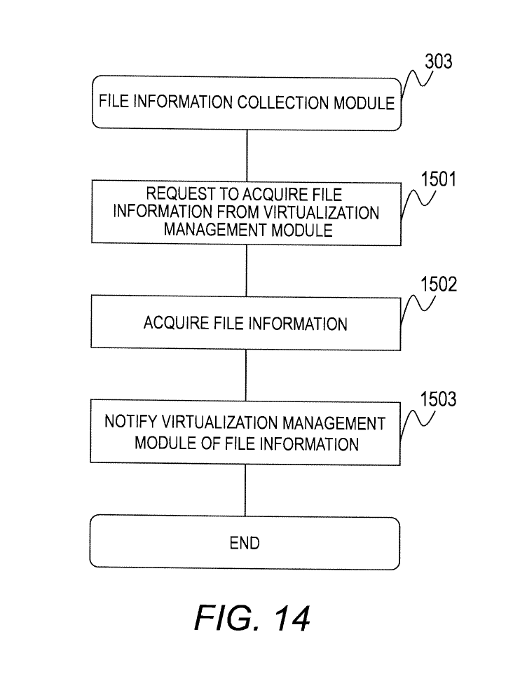

Then, FIG. 14 is a flowchart illustrating an example of the processing carried out in Steps 1304 and 1305 by the file information collection module 303 of the virtualization mechanism 110.

In Step 1501, the file information collection module 303 receives the name (target file name 903) of the patch target file 210 to which the patch file 200 is to be applied and the target virtual server identifier from the virtualization mechanism management module 102.

In Step 1502, the file information collection module 303 searches the virtual disk 120 (original disk) assigned to the virtual server identifier to be targeted to the patch application for a file name coincident with the target file name 903, sets the location of the coincident file as the location of the patch target file 210, and identifies the identifier of the virtual disk 120 storing the patch target file 210.

In Step 1503, the file information collection module 303 notifies the virtualization mechanism management module 102 of the location of the patch target file 210 and the identifier of the virtual disk 120 (original disk) which are identified in Step 1502, and finishes the processing.

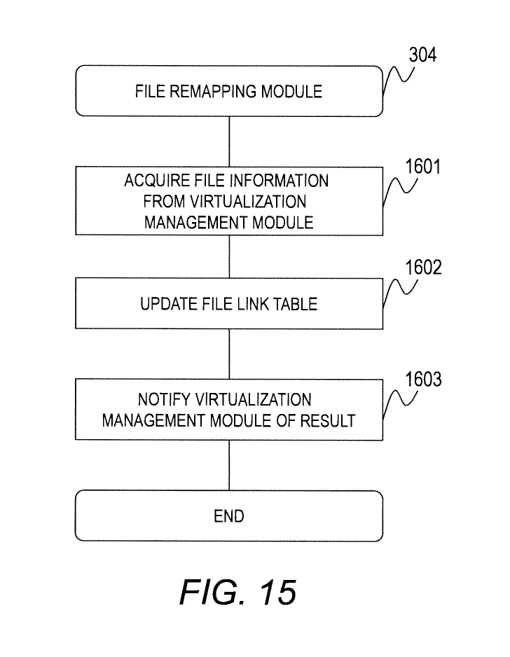

Then, FIG. 15 is a flowchart illustrating an example of the processing carried out in Steps 1306 and 1307 by the file remapping module 304 of the virtual image control module 111.

In Step 1601, the file remapping module 304 receives the target server identifier, the patch identifier 901 of the patch file 200, the identifier (disk volume 904) of the virtual disk 125 (patch disk), the location (patch file information 905) of the patch file 200, the target file name 903, the location of the patch target file 210 acquired in Step 1305, and the identifier of the virtual disk 120 storing the patch target file from the virtualization mechanism management module 102.

In Step 1602, the file remapping module 304 updates the file link table 306 by storing the target virtual server identifier in the virtual machine identifier 1101, the patch identifier 901 of the patch file 200 in the patch identifier 1102, the target file name 903 in the target file name 1103, the identifier of the virtual disk 120 in the original disk volume 1104, the location of the patch target file 210 in the original file information 1105, the identifier (disk volume 904) of the virtual disk 125 (patch disk) in the patch disk volume 1106, and the location (patch file information 905) of the patch file 200 in the patch file information 1107.

Through the above-mentioned processing, the patch target file 210 and the patch file 200 which are not applied to the virtual server 109 out of the patch files 200 registered to the patch management table 106 are registered to the file link table 306.

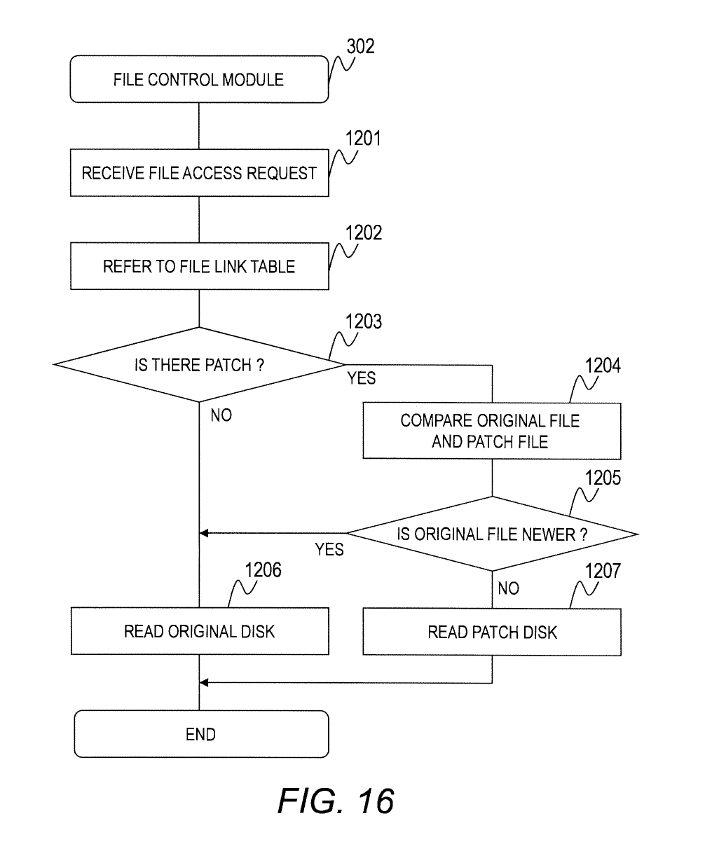

FIG. 16 is a flowchart illustrating an example of processing carried out by the file control module 302 of the virtual image control module 111 illustrated in FIG. 4. This processing is carried out when the OS 301 or an application running on the virtual server 109 accesses a file.

In Step 1201, the file control module 302 receives an access request to a file from the OS 301 or an application of the virtual server 109.

In Step 1202, the file control module 302 acquires a file name of the received file, and refers to the file link table 306.

In Step 1203, when the acquired file name exists in the target file name 1103 of the file link table 306, the file control module 302 determines that the access is directed to the patch target file 210 for which a patch file exists, and proceeds to Step 1204, and otherwise proceeds to Step 1206.

When there is a patch file 200, in Step 1204, the file control module 302 compares a time stamp of the file (patch target file 210) corresponding to the original file information 1105 in the file link table 306 and a time stamp (updated time) of the file (patch file 200) corresponding to the patch file information 1107.

In Step 1205, as a result of the comparison, when the file corresponding to the original file information 1105 is newer than the file corresponding to the patch file information 1107, the file control module 302 proceeds to Step 1206, and when the file corresponding to the patch file information 1107 is newer than the file corresponding to the original file information 1105, the file control module 302 proceeds to Step 1207.

The step 1206 is reached when the file corresponding to the original file information 1105 is newer than the file corresponding to the patch file information 1107, or when there is not a patch file 200, and the file control module 302 reads the requested file from a virtual disk 120, which is an original disk, and returns the file to the OS 301 of the virtual server 109.

The step 1207 is reached when the patch file 200 corresponding to the patch file information 1107 is newer than the patch target file 210 corresponding to the original file information 1105, the file control module 302 reads the requested patch file 200 from a virtual disk 125, which is a patch disk, and returns the file to the OS 301 of the virtual server 109.

As a result of the above-mentioned processing, when the patch file 200 is newer than the patch target file 210 on the original disk, the OS 301 or the application can be operated in the same state as a state after the application of the patch file 200 by reading the patch file 200 from the patch disk in place of the original disk, and returning the patch file 200 to the OS 301 without applying the patch file 200 to the patch target file 210 on the original disk, and vulnerability in security and a bug can be quickly restrained.

The example in which a newer file out of the file corresponding to the patch file information 1107 and the file corresponding to the original file information 1105 is read in Steps 1204 and 1205 is described in the above-mentioned processing. However, as illustrated in FIG. 4, when there is a patch file 200, a patch target file 210 may be hidden, and a patch file 200 may be read from a patch disk without comparing, in chronological order, the file corresponding to the patch file information 1107 and the file corresponding to the original file information 1105.

Moreover, when the access request to the file is writing in the processing in Step 1201, the writing is made to the requested file, and the processing may be finished.

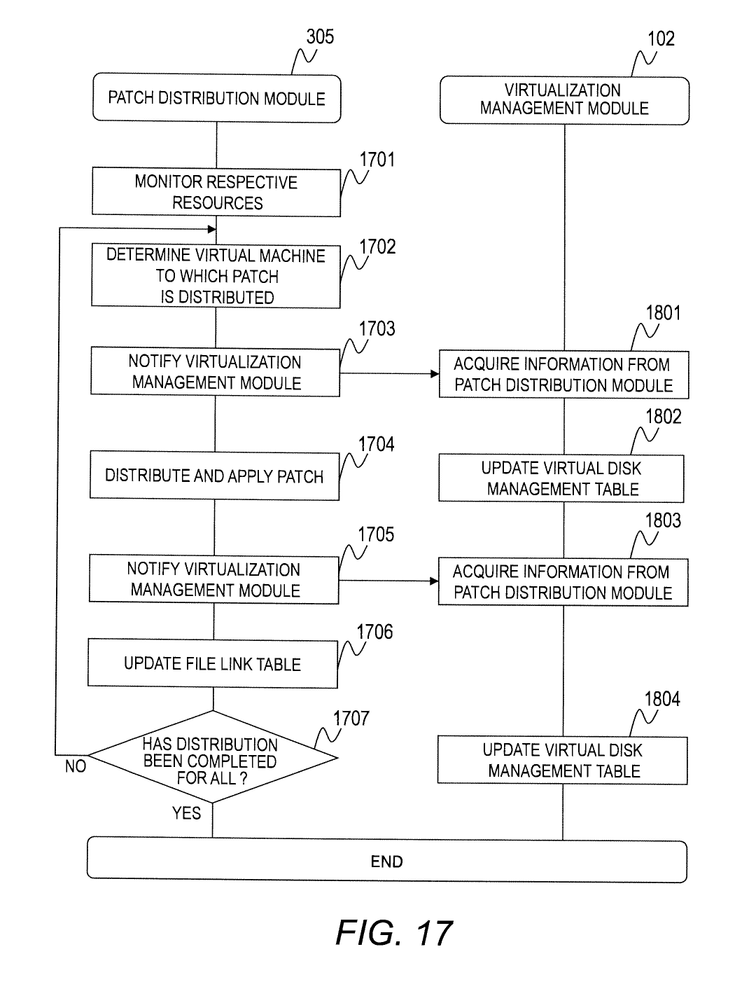

FIG. 17 is a flowchart illustrating an example of the patch distribution processing carried out by the patch distribution module 305 in the virtual image control module 111. This processing may be carried out background by the virtualization mechanism 110.

In Step 1701, the patch distribution module 305 monitors a load on a resource in the physical server 112. The usage of the processor 202 (physical processor) or the usage of the storage apparatus 113 or the network 108 described above may be used as the load on the resource of the physical server 112. Moreover, a usage of a virtual processor provided by the virtualization mechanism 110 may be monitored as the usage of the processor 202.

In Step 1702, when the monitored load becomes less than a predetermined threshold, a virtual server 109 to which a patch file 200 is to be applied is determined under a predetermined condition. For example, this predetermined condition is that, within the number of parallel pieces of processing set in advance, a plurality of virtual servers 109 provided by the virtualization mechanism 110 are selected. For example, when the number of parallel pieces of processing is two, two of the virtual servers 109 are processed at a time. The patch distribution module 305 refers to the file link table 306, and selects a patch file 200 and a patch target file 210 for each of the virtual servers 109.

In Step 1703, the patch distribution module 305 notifies the virtualization mechanism management module 102 of the virtual servers 109 and the patch files 200 determined in Step 1702.

The virtualization mechanism management module 102 updates the status 1005 in the virtual disk management table 107 to APPLYING for each of the virtual servers 109 to which patches are applied and each of the patch files 200, which are received from the patch distribution module 305 (1801 and 1802).

In Step 1704, the patch distribution module 305 reads the patch files 200 from the patch disk, and carries out the application of the patches by updating patch target files 210 on virtual disks 120 assigned to the virtual servers 109 to which the patches are to be applied.

In Step 1705, the patch distribution module 305 updates the patch target files 210 by using the patch files 200, and notifies the virtualization mechanism management module 102 of the completion of the patch application.

The virtualization mechanism management module 102 updates the status 1005 in the virtual disk management table 107 to APPLIED for each of the virtual servers 109 and each of the patch files 200 according to the completion notification of the patches received from the patch distribution module 305 (1804). Moreover, when all patch files 200 corresponding to a patch identifier stored in the link patch 1003 in the virtual disk management table 107 have been applied, the virtualization mechanism management module 102 retrieves a virtual server 109 to which the virtual disk identifier 1001 is assigned from assigned resources 804 in the virtual server management table 105, and adds the patch identifier to applied patches 806. Moreover, when statuses 1005 of all patch files 200 corresponding to a link patch 1003 in the virtual disk management table 107 become “APPLIED”, the virtualization mechanism management module 102 updates a link patch 1003, file information 1004, and a status 1005 corresponding to a virtual disk identifier 1001 to which the patch files 200 have been applied to NULL. Alternatively, records corresponding to the virtual disk identifier 1001 to which the patch files 200 have been applied may be deleted.

In Step 1706, the patch distribution module 305 updates the file link table 306 by deleting the records to which the patches have been applied. As a result, an access by the file control module 302 to a file to which a patch is applied is directed to an original disk, resulting in restraint of the processing load from increasing.

In Step 1707, the patch distribution module 305 determines whether all the target patch files 200 haven been applied to the presently selected virtual servers 109, and when the application has been completed, the patch distribution module 305 finishes the processing, and otherwise returns to Step 1702 and carries out the application of a patch for next patch files 200 or remaining virtual servers 109.

As a result of the above-mentioned processing, the patch distribution module 305 has updated the patch target files 210 by using the patch files 200, and deletes the records in the file link table 306. Moreover, the virtualization mechanism management module 102 updates the applied patches 806 in the virtual server management table 105, and records of link patches 1003 whose patch files 200 are APPLIED are updated to NULL (or deleted), and are discarded in the virtual disk management table 107.

It should be noted that the administrator of the management server 101 or the like can manually manage the patch management table 106.

Moreover, though the example in which the patch distribution module 305 detects the load on the physical server 112 and automatically applies patches is described in the processing of FIG. 17, the monitoring of the load in Step 1701 may be omitted, and the processing subsequent to Step 1702 may be carried out under an instruction by the administrator of the management server 101 or the like. In other words, the patch distribution module 305 may carry out the processing subsequent to Step 1702, assuming that the predetermined condition is satisfied when the load on the physical server 112 becomes less than the threshold, or when the instruction from the administrator or the like is received.

The virtual servers 109 to which the patch files 200 are applied may be determined so that one out of the plurality of virtual servers 109 is selected at a time, and a patch file 200 for each thereof may be applied.

Though the example in which the file control module 302 reads a file and returns the file to the virtual server 109 is described in the embodiment described above, the file control module 302 may switch between an access path to the original disk and an access path to the patch disk, thereby permitting a virtual server 109 to access any one of those disks.

According to the embodiment of this invention, each of the virtual computers reads a common correction file (patch file) from the second storage unit in accordance with the file link information, thereby entering into a state in which the correction file is applied, and the correction file can be applied collectively to the plurality of virtual computers only by changing links to a file in the first storage unit to be accessed by the virtual computer and the correction file in the second storage unit.

Moreover, when a stopped computer is started, by setting file link information on a file in the first storage unit to be accessed by a virtual computer to a correction file in the second storage unit, the virtual computer is caused to use the correction file upon the startup, thereby bringing the virtual server into a state in which the correction file is applied.

Though the detailed description has been given of this invention referring to the attached drawings, this invention is not limited to this specific configuration, and includes various variations and equivalent configurations within the scope of the accompanying claims.

As described above, this invention can be applied particularly to a virtual computer system provided with virtualization mechanisms respectively in a plurality of physical servers, and provided with a management server for managing each of the virtualization mechanisms.

What is claimed is:

1. A virtual computer system, comprising:
a physical computer including a processor and a memory;
a virtualization unit for providing a virtual computer by dividing a resource of the physical computer; and
a storage apparatus accessible from the physical computer, wherein:
the storage apparatus includes
a first storage unit storing a plurality of files for starting the virtual computer, and
a second storage unit storing a correction file to be applied to the file;
the virtualization unit includes
file link information containing a correspondence relation between a file in the first storage unit and a correction file in the second storage unit, which is to be applied to the file, and
a file control unit for controlling access from the virtual computer to the file in the storage apparatus; and
the file control unit is configured to
receive an access from the virtual computer to a file stored in the first storage unit,
determine whether absence or presence of a correction file to be applied to the file by referring to the file link information,
provide the file for which the access has been received to the virtual computer from the first storage unit in a case where there is no correction file to be applied to the file, and
provide a correction file in the second storage unit to the virtual computer as the file for which the access has been received in a case where there is the correction file to be applied to the file.

2. The virtual computer system according to claim 1, wherein the virtualization unit further includes a distribution unit for updating the file stored in the first storage unit by using the correction file stored in the second storage unit in a case where a predetermined condition is satisfied.

3. The virtual computer system according to claim 2, wherein the distribution unit discards the correspondence relation between the file and the correction file contained in the file link information after updating the file in the first storage unit by using the correction file in the second storage unit.

4. The virtual computer system according to claim 1, wherein the file control unit is configured to:
compare an update time of the correction file stored in the second storage unit and an update time of the file stored in the first storage unit in a case where there is a correction file for the file; and
provide the file stored in the first storage unit to the virtual computer as the file for which the access has been received in a case where the update time of the file stored in the first storage unit is newer than the update time of the correction file stored in the second storage unit.

5. The virtual computer system according to claim 1, wherein:
the physical computer further includes a plurality of the physical computers each having the virtualization unit;
the virtual computer system further includes a management computer for managing a plurality of the virtualization units and the storage apparatus;
the management computer includes
correction file management information for managing a storage location of the correction file in the second storage unit, and a name of the file in the first storage unit to which the correction file is to be applied, and
a management unit for managing the plurality of the virtualization units and the correction file management information; and
the virtualization unit of each of the plurality of the physical computers is configured to
acquire the storage location of the correction file in the second storage unit and the name of the file to which the correction file is to be applied from the management unit
acquire a storage location of the file having the acquired name in the first storage unit, and
set, to the file link information, a correspondence relation between the storage location of the file in the first storage unit and the storage location of the correction file to be applied to the file in the second storage unit.

6. The virtual computer system according to claim 5, wherein:
the management unit is configured to
add the new correction file to the correction file management information in a case where a new correction file is stored in the second storage unit, and
notify the new correction file to the file control unit of each of the plurality of the virtualization units; and
the plurality of the virtualization units set the file link information in accordance with the notification from the management unit.

7. The virtual computer system according to claim 5, wherein:
the virtualization unit further includes a distribution unit for updating the file stored in the first storage unit by using the correction file stored in the second storage unit in a case where a predetermined condition is satisfied;
the management unit of the management computer manages virtual computer management information for managing, for each virtual computer, the first storage unit to be accessed by the virtual computer;
the virtual computer management information contains an identifier of the file stored in the first storage unit and an application state of the correction file which corresponds to the file and is stored in the second storage unit;
the distribution unit notifies the management unit of a state of update of the file stored in the first storage unit, which is carried out by using the correction file stored in the second storage unit; and
the management unit receives the notification from the distribution unit, and sets the file stored in the first storage unit and the application state of the correction file which corresponds to the file and is stored in the second storage unit.

8. A control method for a virtual computer system, the virtual computer system including:
a physical computer including a processor and a memory;
a virtualization unit for providing a virtual computer by dividing a resource of the physical computer; and
a storage apparatus accessible from the physical computer,
the storage apparatus including:
a first storage unit storing a plurality of files for starting the virtual computer; and
a second storage unit storing a correction file to be applied to the file,
the virtualization unit including:
file link information containing a correspondence relation between a file in the first storage unit and a correction file in the second storage unit, which is to be applied to the file; and
a file control unit for controlling access from the virtual computer to the file in the storage apparatus,
the control method including:
a reception step of receiving, by the file control unit, an access from the virtual computer to a file stored in the first storage unit;
a determination step of determining, by the file control unit, whether absence or presence of a correction file to be applied to the file by referring to the file link information;
a request file providing step of providing, by the virtualization unit the file for which the access has been received to the virtual computer from the first storage unit in a case where there is no correction file to be applied to the file; and
a correction file providing step of providing, by the virtualization unit the correction file in the second storage unit to the virtual computer as the file for which the access has been received in a case where there is a correction file to be applied to the file.

9. The control method for a virtual computer according to claim 8, further including a step of updating, by the virtualization unit the file stored in the first storage unit by using the correction file stored in the second storage unit in a case where a predetermined condition is satisfied.

10. The control method for a virtual computer according to claim 9, further including a step of discarding, by the virtualization unit the correspondence relation between the file and the correction file contained in the file link information after updating the file in the first storage unit by using the correction file in the second storage unit.

11. The control method for a virtual computer according to claim 8, wherein:
the correction file providing step includes comparing, by the virtualization unit, an update time of the correction file stored in the second storage unit and an update time of the file stored in the first storage unit; and
the correction file providing step includes providing the file stored in the first storage unit to the virtual computer as the file for which the access has been received in a case where the update time of the file stored in the first storage unit is newer than the update time of the correction file stored in the second storage unit.

12. The control method for a virtual computer according to claim 8, wherein:
the physical computer includes a plurality of the physical computers each having the virtualization unit;
the virtual computer system further includes a management computer for managing a plurality of the virtualization units and the storage apparatus;
the control method further includes the steps of
setting, by the management computer, correction file management information containing a storage location of the correction file in the second storage unit, and a name of the file in the first storage unit to which the correction file is to be applied,
acquiring, by the virtualization unit the storage location of the correction file in the second storage unit and the name of the file to which the correction file is to be applied from a management unit,
acquiring, by the virtualization unit, a storage location of the file having the acquired name in the first storage unit, and
setting, by the virtualization unit, to the file link information, a correspondence relation between the storage location of the file in the first storage unit and the storage location of the correction file to be applied to the file in the second storage unit.

13. The control method for a virtual computer according to claim 12, further comprising the steps of:
adding, by the management unit the new correction file to the correction file management information in a case where a new correction file is stored in the second storage unit;
notifying, by the management unit, the new correction file to the file control unit of each of the plurality of the virtualization units; and
setting, by the plurality of the virtualization units, the file link information in accordance with the notification from the management unit.

14. The control method for a virtual computer according to claim 12, further including the steps of:
managing, by the management unit, for each virtual computer, the first storage unit to be accessed by the virtual computer, and setting virtual computer management information containing an identifier of the file stored in the first storage unit and an application state of the correction file which corresponds to the file and is stored in the second storage unit;
notifying, by the distribution unit, the management unit of a state of update of the file stored in the first storage unit, which is carried out by using the correction file stored in the second storage unit; and
receiving, by the management module, the notification from a distribution module, and setting the file stored in the first storage unit and the application state of the correction file which corresponds to the file and is stored in the second storage unit.
